(19) United States
(12) Patent Application Publication
(10) Pub. No.: US 2026/0166524 A1
(43) Pub. Date: Jun. 18, 2026

(54) PLATINUM IMPREGNATED ZINC OXIDE-ALUMINA CATALYST AND METHOD OF PREPARATION THEREOF

(71) Applicant: Bharat Petroleum Corporation Limited, Greater Noida (IN)

(72) Inventors: Arundhathi RACHA, Greater Noida (IN); Biswajit SAHA, Greater Noida (IN); Chanchal SAMANTA, Greater Noida (IN); Bharat Laxman NEWALKAR, Greater Noida (IN)

(21) Appl. No.: 19/418,547

(22) Filed: Dec. 12, 2025

(30) Foreign Application Priority Data
Dec. 13, 2024 (IN) 202411098851

(51) Int. Cl. B01J 23/60; B01J 21/04; B01J 35/61; B01J 35/63; B01J 35/64; B01J 37/02; B01J 37/12; B01J 37/16

(52) U.S. Cl. CPC B01J 23/60; B01J 21/04; B01J 35/615; B01J 35/635; B01J 35/647; B01J 37/0213; B01J 37/12; B01J 37/16; B01J 2235/15

(57) ABSTRACT

The present disclosure relates to a platinum impregnated zinc oxide-alumina (Pt/ZnO—Al₂O₃) catalyst and its method of preparation. The method comprising: a) mixing of a zinc metal salt and an aluminum metal salt in water to obtain a metal salt solution; b) mixing of at least one base in water to obtain a base solution; c) adding the metal salt solution of step a) in the base solution of step b) causes co-precipitation to obtain a precipitate; d) processing the precipitate by washing followed by drying and calcination to obtain a zinc oxide-alumina (ZnO—Al₂O₃) support; e) dispersing the ZnO—Al₂O₃ support in water with stirring to obtain a ZnO—Al₂O₃ support solution; f) dissolving a platinum metal precursor in water to obtain a platinum metal precursor solution; and g) mixing of ZnO—Al₂O₃ support solution of step e) with the platinum metal precursor solution to obtain a semi-solid solution followed by drying, calcination and reduced under condition to obtain a platinum impregnated zinc oxide-alumina (Pt/ZnO—Al₂O₃) catalyst.

### CROSS REFERENCE TO RELATED APPLICATION(S)

This application is related to and claims priority to Indian Patent Application number 202411098851 filed on Dec. 13, 2024, the contents of which are incorporated by reference herein.

### FIELD OF THE INVENTION

The present disclosure generally relate to a field of catalysis and material science. More particularly, the present disclosure relates to a platinum impregnated zinc oxide-alumina (Pt/ZnO—Al₂O₃) catalyst. The present disclosure also relates to a method of preparation of a platinum impregnated zinc oxide-alumina (Pt/ZnO—Al₂O₃) catalyst.

### BACKGROUND

Background description includes information that may be useful in understanding the present invention. It is not an admission that any of the information provided herein is prior art or relevant to the presently claimed invention, or that any publication specifically or implicitly referenced is prior art.

CN105457641A discloses the preparation of a Cu/ZnO—Al₂O₃ catalyst for methanol synthesis from syngas wherein the ZnO—Al₂O₃ support is prepared by co-precipitation method, involving the steps of preparing a mixed solution of zinc nitrate and aluminum nitrate and an alkaline precipitator solution (Na₂CO₃ or NaOH), adding the alkaline precipitator solution into the mixed solution till the pH is 7, and then washing, drying and roasting (300-500° C.) the mixed solution to obtain a ZnO—Al₂O₃ carrier. Copper is incorporated by in-situ reduction deposition, involving the steps of preparing an ammonia water solution and a reducing agent (e.g. sodium borohydride) solution of copper sulfate, dispersing the ZnO—Al₂O₃ carrier in a sodium hydroxide solution, at 40-70° C., simultaneously adding the ammonia water solution and the reducing agent solution of the copper salt into the sodium hydroxide solution containing the carrier, continuously stirring the solution after addition; and finally, washing, drying, roasting (250-400° C.) and moulding a solid obtained by solid-liquid separation to obtain the copper, zinc and aluminum catalyst.

Park et al. [Applied Catalysis A: General, 2001, 211, 81-90] discloses the development of ZnO/Al₂O₃ catalysts for reverse-water-gas-shift reaction of CAMERE (carbon dioxide hydrogenation to form methanol via a reverse-water-gas-shift reaction) process wherein ZnO/Al₂O₃ catalysts of various compositions (Zn:Al 4:1 to 1:2) were prepared by co-precipitation of the corresponding metal nitrates and the catalysts were calcined at 773K (500° C.) or 1123 K (850° C.) for 3 h.

Hartfelder et al. [Sci Rep., 2016, 6, 37597] discloses a Pt/Al₂O₃ catalyst prepared by incipient wetness impregnation wherein tetra amine platinum nitrate was dissolved in deionized water, resulting solution added dropwise to aluminum oxide with constant mixing, for a metal loading of 1 wt %, and the resulting mixture was calcined under air at 500° C. for 5 h, then reduced in a flow of 100 mL/min of 5% H₂/He for 2 h at 250° C.

US2007149392A1 discloses a multifunctional catalyst system comprising a first and a second catalyst wherein the first catalyst is a reverse water gas shift (RWGS) reaction catalyst for reduction of CO₂ with H₂ to form CO, and comprises zinc oxide disposed upon an alumina substrate, or platinum disposed upon a ceria substrate.

US2007142482A1 discloses a reverse water gas shift (RWGS) conversion of CO₂ by reacting with hydrogen at 400-1200° C. and 1-100 atmospheric pressure, in the presence of a catalyst such as ZnO co-precipitated with Al₂O₃, the content of ZnO being 10-90% by weight based of the total weight of the catalyst, to provide a CO rich stream.

The drawbacks of the above prior arts are that the product (CO) selectivity is comparatively low and the operating temperature considerably high in these reported methods.

Therefore, there is a need for the development of a novel catalyst having improved properties and carbon dioxide conversion with carbon monoxide selectivity.

### OBJECTS OF THE INVENTION

An object of the present disclosure to develop a novel platinum impregnated zinc oxide-alumina (Pt/ZnO—Al₂O₃) catalyst.

Another object of the present disclosure to provide a method of preparation of a platinum impregnated zinc oxide-alumina (Pt/ZnO—Al₂O₃) catalyst.

Still another object of the present disclosure is to provide a novel catalyst with improved pore volume, pore size and surface area.

Yet another object of the present disclosure to provide a novel catalyst with improved carbon dioxide conversion with carbon monoxide selectivity at a lower operating temperature.

### SUMMARY OF THE INVENTION

This summary is provided to introduce a selection of concepts in a simplified form that are further described below in Detailed Description section. This summary is not intended to identify key features or essential features of the claimed subject matter, nor is it intended to be used as an aid in determining the scope of the claimed subject matter.

An aspect of the present disclosure is to provide a platinum impregnated zinc oxide-alumina (Pt/ZnO—Al₂O₃) catalyst comprising: a zinc oxide-alumina (ZnO—Al₂O₃) support; and a platinum (Pt) impregnated onto the ZnO—Al₂O₃ support, wherein the platinum content is in the range of 0.6 to 1.2% w/w of the total weight of the catalyst.

Another aspect of the present disclosure is to provide a method of preparation of a platinum impregnated zinc oxide-alumina (Pt/ZnO—Al₂O₃) catalyst comprising: a) mixing of a zinc metal salt and an aluminum metal salt in water to obtain a metal salt solution; b) mixing of at least one base in water to obtain a base solution; c) adding the metal salt solution of step a) in the base solution of step b) causes co-precipitation to obtain a precipitate; d) processing the precipitate by washing followed by drying and calcination to obtain a zinc oxide-alumina (ZnO—Al₂O₃) support; e) dispersing the ZnO—Al₂O₃ support in water with stirring to obtain a ZnO—Al₂O₃ support solution; f) dissolving a platinum metal precursor in water to obtain a platinum metal precursor solution; and g) mixing of ZnO—Al₂O₃ support solution of step e) with the platinum metal precursor solution to obtain a semi-solid solution followed by drying, calcination and reduced under condition to obtain a platinum impregnated zinc oxide-alumina (Pt/ZnO—Al₂O₃) catalyst.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and together with the description, serve to explain the principles of the present disclosure.

FIG. 1 illustrates XRD pattern of the synthesized catalysts.

FIG. 2 illustrates NH₃ TPD profile of the synthesized samples.

FIG. 3 illustrates catalytic activity data. Reaction conditions: T (450° C.), P (20 bar), H₂:CO₂ (3:1), GHSV (4470 h⁻¹).

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The recitation of ranges of values herein is merely intended to serve as a shorthand method of referring individually to each separate value falling within the range.

Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

Reference will now be made in detail to the exemplary embodiments of the present invention, examples of which are illustrated in the accompanying drawings.

The following description provides different examples and embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

All percentages, ratios, and proportions used herein are based on a weight basis unless otherwise specified.

Various terms as used herein are shown below. To the extent a term used in a claim is not defined below, it should be given the broadest definition persons in the pertinent art have given that term as reflected in printed publications and issued patents at the time of filing.

An embodiment of the present disclosure provides a platinum impregnated zinc oxide-alumina (Pt/ZnO—Al₂O₃) catalyst comprising: a zinc oxide-alumina (ZnO—Al₂O₃) support; and a platinum (Pt) impregnated onto the ZnO—Al₂O₃ support, wherein the platinum content is in the range of 0.6 to 1.2% w/w of the total weight of the catalyst.

In an embodiment, the catalyst has pore volume in the range of 0.5 to 0.6 cm³/g, pore size in the range of 125 to 135 Å and surface are in the range of 110 to 120 m²/g.

In a preferred embodiment, the pore volume of the catalyst is in the range of 0.51 to 0.59 cm³/g or 0.52 to 0.58 cm³/g or 0.53 to 0.57 cm³/g or 0.54 to 0.56 cm³/g or 0.55 cm³/g.

In a preferred embodiment, the pore size of the catalyst is in the range of 126 to 134 Å or 127 to 133 Å or 128 to 132 Å or 129 to 131 Å.

In a preferred embodiment, the surface of the catalyst is in the range of 111 to 119 m²/g or 112 to 118 m²/g or 113 to 117 m²/g or 114 to 116 m²/g.

Another embodiment of the present disclosure provides a method of preparation of a platinum impregnated zinc oxide-alumina (Pt/ZnO—Al₂O₃) catalyst comprising: a) mixing of a zinc metal salt and an aluminum metal salt in water to obtain a metal salt solution; b) mixing of at least one base in water to obtain a base solution; c) adding the metal salt solution of step a) in the base solution of step b) causes co-precipitation to obtain a precipitate; d) processing the precipitate by washing followed by drying and calcination to obtain a zinc oxide-alumina (ZnO—Al₂O₃) support; e) dispersing the ZnO—Al₂O₃ support in water with stirring to obtain a ZnO—Al₂O₃ support solution; f) dissolving a platinum metal precursor in water to obtain a platinum metal precursor solution; and g) mixing of ZnO—Al₂O₃ support solution of step e) with the platinum metal precursor solution to obtain a semi-solid solution followed by drying, calcination and reduced under condition to obtain a platinum impregnated zinc oxide-alumina (Pt/ZnO—Al₂O₃) catalyst.

In an embodiment, the zinc metal salt is selected from a group consisting of zinc nitrate hexahydrate, zinc chloride, zinc acetate, zinc chlorate and combination thereof. Preferably, the zinc metal salt is zinc nitrate hexahydrate.

In an embodiment, the aluminum metal salt is selected from a group consisting of aluminum nitrate nonahydrate, aluminum isopropoxide, aluminum chloride hexahydrate and combination thereof. Preferably, the aluminum metal salt is aluminum nitrate nonahydrate.

In an embodiment, the base is selected from a group consisting of sodium carbonate, sodium hydroxide, sodium acetate, sodium hypochlorite and combination thereof. Preferably, the base is a mixture of sodium carbonate and sodium hydroxide.

In an embodiment, the zinc metal salt and the aluminum metal salt are added in a mole ratio of 3:1.

In an embodiment, the precipitate in step c) has a age for 2 hrs at a temperature of 60° C. and having a pH in the range of 7 to 7.5.

In an embodiment, the precipitate in step d) is washed with warm water followed by drying at a temperature in the range of 100-120° C. for a period in the range of 8 to 12 hrs and calcined at a temperature in the range of 500-600° C. for a period in the range of 4 to 6 hrs with 1° C./min ramp rate. Preferably, the drying and calcination are carried out at a temperature of 110° C. for a period of 10 hrs and 550° C. for a period of 5 hrs respectively.

In an embodiment, the platinum metal precursor is selected from a group consisting of tetra-amine platinum (II) nitrate, chloroplatinic acid hexahydrate, and combination thereof and is added in an amount in the range of 0.6 to 1.2% w/w. Preferably, the platinum metal precursor is tetra-amine platinum (II) nitrate and is added in an amount of 1% w/w.

In an embodiment, the drying in step g) is carried out at a temperature in the range of 100-120° C. for a period in the range of 8 to 12 hrs and calcined at a temperature in the range of 300-500° C. for a period in the range of 3 to 5 hrs with 1° C./min ramp rate. Preferably, the drying and calcination are carried out at a temperature of 110° C. for a period of 10 hrs and 400° C. for a period of 4 hrs.

In an embodiment, the reduction in step g) is carried out by (i) in-situ reduction with sodium hydroborate and (ii) normal reduction using hydrogen and nitrogen with 50 ml/min and 950 ml/min respectively at 300° C. for 2 hrs or combination thereof.

While the foregoing describes various embodiments of the disclosure, other and further embodiments of the disclosure may be devised without departing from the basic scope thereof. The invention is not limited to the described embodiments, versions or examples, which are included to enable a person having ordinary skill in the art to make and use the invention when combined with information and knowledge available to the person skilled in the art.

### EXAMPLES

The present disclosure is further explained in the form of the following examples. However, it is to be understood that the examples are merely illustrative and are not to be taken as limitations upon the scope of the invention. Various changes and modifications to the disclosed embodiments will be apparent to those skilled in the art. Such changes and modifications may be made without departing from the scope and spirit of the present invention.

### Example 1

(I) Pt/ZnO—Al₂O₃ Catalyst Synthesis Procedure for RWGS of CO₂
(A) Synthesis of ZnO—Al₂O₃ Support

The support ZnO—Al₂O₃ was prepared using the co-precipitation method using 0.5 M of metal salt and 0.5 M of the base solution. The metal salt solution was prepared by mixing 39.98 g of zinc nitrate hexahydrate and 16.82 g of aluminum nitrate nonahydrate in 332.86 ml of distilled water with zinc to alumina mole ratio 3:1. Whereas the base solution was prepared by mixing 21.18 g of sodium carbonate and 16.13 g of sodium hydroxide in 1200 ml of distilled water. After that, both solutions were added dropwise in a double-jacketed glass reactor using the pumps. The Co-precipitation was continued in this reactor till the whole of the metal solution was pumped into the reactor. Finally, a milky white precipitate was observed, which was aged for two hours at 60° C. The pH of the precipitate should be 7 to 7.5, therefore the precipitate was continuously washed with warm water until the precipitate was base-free. Then the precipitate was dried the whole night at 110° C. followed by calcination at 550° C. for 5 h with a 1° C./min ramp rate.

(B) Impregnation Pt in ZnO—Al₂O₃ Support

The ZnO—Al₂O₃ support was well dispersed in distilled water by stirring. Then 0.6 wt % Pt was impregnated via the wet impregnation method by dissolving the required amount (0.119 g) of tetra-amine platinum (II) nitrate in water followed by mixing this metal precursor solution with ZnO—Al₂O₃ support solution. A white semi-solid type solution was observed which was dried overnight at 110° C. followed by calcination at 400° C. for 4 h with a 1° C./min ramp rate. Finally, this Pt-impregnated ZnO—Al₂O₃ catalyst was reduced in two ways (i) in-situ reduction with sodium hydroborate and (ii) normal reduction using hydrogen and nitrogen with 50 ml/min and 950 ml/min respectively at 300° C. for 2 hr.

(C) Preparation of CuO—ZnO—Al₂O₃(Comparative Example)

The hydrotalcite-like catalysts were synthesized through the co-precipitation method. Cu(NO₃)₂·2.5H₂O (99%, Sigma), Zn(NO₃)₂·6H₂O (98%, Loba Chemie), Al(NO₃)₃·9H₂O (98%, Loba Chemie), ZrO(NO₃)₂·xH₂O (98%, Loba chemie), Zirconium (IV) oxynitrate hydrate, In(NO₃)₃·H₂O (99.9%, SRL), Na₂CO₃ (99.5%, Loba chemie), and NaOH (97%, Loba chemie), precursor salts were dissolved in the deionized water to make the 0.5M precursor solution. For example, the required amount of Cu(NO₃)₂·2.5H₂O (Sigma), Zn(NO₃)₂·6H₂O (Loba Chemie), and Al(NO₃)₃·9H₂O (Loba Chemie) precursor salts were dissolved in the deionized water to make the 0.5M precursor solution. A uniform precursor solution was prepared by thorough mixing. The co-precipitation was carried out at room temperature with 1M Na₂CO₃ aqueous solution. The precipitation was carried out in a continuously stirred jacketed reactor system (Reactor Ready) by maintaining the pH at 8. Prior to the precipitation, 200 ml of deionized water was taken in the jacketed reactor system. Furthermore, both the precursor and Na₂CO₃ solutions were added dropwise under vigorous stirring. The resulting precipitate was aged at 60° C. for two hours. Furthermore, the precipitate was filtered and washed with deionized water until the pH of the filtrate became 7. The washed sample was dried at 110° C. for 12 h followed by calcination at 350° C. All the calcined samples are denoted as CTM catalysts.

### (II) Characterization of Catalysts

### (A) Properties of the Catalysts

The pore volume, pore size and surface area of the prepared catalyst were evaluated. The results are shown in Table 1. The Pt/ZnO—Al₂O₃ of the present disclosure showed pore volume pore size and surface area of 0.55 cm³/g, 129.3 Å and 115.4 m²/g respectively which indicate that the properties of the present catalyst is much better than the ZnO—Al₂O₃ and CuO—ZnO—Al₂O₃.

TABLE 1
BET surface area.

| | Pore volume | Pore size | Surface area |
|---|---|---|---|
| Catalyst | (cm³/g) | (Å) | (m²/g) |
| ZnO—Al₂O₃ | 0.48 | 102.69 | 93.5 |
| CuO—ZnO—Al₂O₃ | 0.18 | 45.19 | 73.2 |
| Pt/ZnO—Al₂O₃ | 0.55 | 129.3 | 115.4 |

### (B) XRD Analysis

The XRD analysis was carried out for the synthesized catalyst as shown in FIG. 1. The XRD analysis showed that after Pt impregnation in support, the intensity of Pt peak was weak compared to Cu-impregnated ZnO—Al₂O₃ catalyst, which implies that Pt has good dispersion on support compared to Cu due to low concentration compared to copper.

### (C) NH₃-TPD Analysis

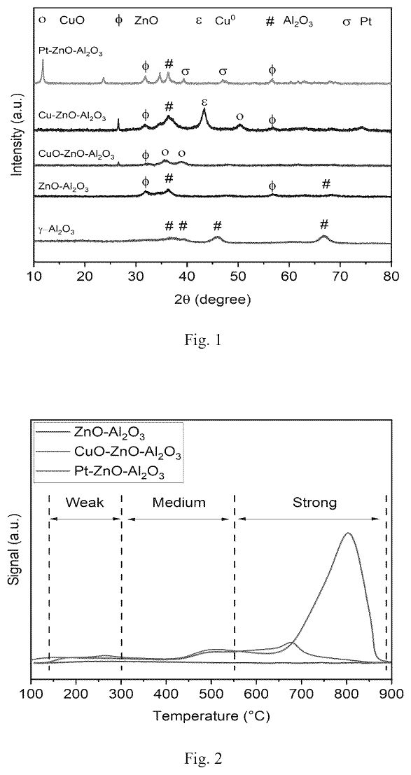

The NH₃-TPD analysis was carried out for the synthesized catalyst as shown in FIG. 2. The NH₃-TPD analysis implies that the support (ZnO—Al₂O₃) was basic in nature but after Cu and Pt impregnation both catalysts have medium and strong acidic active sites which play an important role in the reaction.

### (III) Catalyst Performance

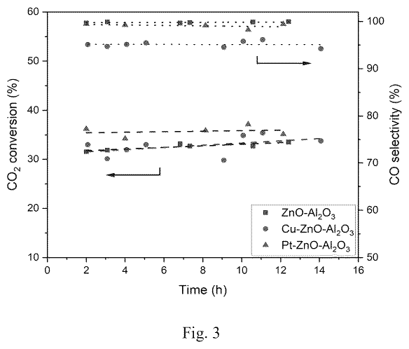

Catalytic performance was carried out for comparative examples ZnO—Al₂O₃ and Cu—ZnO—Al₂O₃ along with the present catalyst Pt—ZnO—Al₂O₃. The results are shown in Table 2 and FIG. 3. The CO₂ conversion at 10 bar and 20 bar for ZnO—Al₂O₃ catalyst was found 30.4% and 32.6% respectively. The CO₂ conversion at 10 bar and 20 bar at different temperature for Cu—ZnO—Al₂O₃ catalyst was found in the range of 14.2% to 27.9% and 19.5% to 33% respectively. Whereas the Pt—ZnO—Al₂O₃ catalyst of the present disclosure showed CO₂ conversion at 10 bar and 20 bar as 32% and 35% respectively with CO selectivity 99.0 and 99.9% respectively. The results of the catalytic performance showed that both CO₂ conversion and CO selectivity are much better than the ZnO—Al₂O₃ and Cu—ZnO—Al₂O₃ as shown in Table 2.

TABLE 2
Catalytic performance of the catalyst.

| | Preparation | T | P | | GHSV | CO₂ | CO selectivity |
|---|---|---|---|---|---|---|---|
| Catalyst | method | (° C.) | (bar) | CO₂:H₂ | (h⁻¹) | conv (%) | (%) |
| ZnO- | Co- | 450 | 10 | 1:1 | 4470 | 30.4 | 99.9 |
| Al₂O₃ | precipitation | | 20 | | | 32.6 | 99.7 |
| Cu-ZnO- | Co- | 300 | 10 | | | 14.2 | 98.1 |
| Al₂O₃ | precipitation | 350 | | | | 20.5 | 98.9 |
| | | 400 | | | | 23.4 | 98.8 |
| | | 450 | | | | 27.9 | 99.3 |
| | | 300 | 20 | | | 19.5 | 85.9 |
| | | 350 | | | | 22.2 | 84.5 |
| | | 400 | | | | 29.2 | 85.9 |
| | | 450 | | | | 33.0 | 95.0 |
| Pt-ZnO- | Co- | 450 | 10 | | | 32 | 99.0 |
| Al₂O₃ | precipitation | | 20 | | | 35 | 99.9 |
| | & In-situ | | | | | | |
| | reduction | | | | | | |

The foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Advantages of the Present Invention

The Pt/ZnO—Al₂O₃ catalyst of the present disclosure showed pore volume, pore size and surface area of 0.55 cm³/g, 129.3 Å and 115.4 m²/g respectively indicating that the properties of the present catalyst are much better than the ZnO—Al₂O₃ and CuO—ZnO—Al₂O₃ catalyst.

The Pt—ZnO—Al₂O₃ catalyst of the present disclosure showed CO₂ conversion at 10 bar and 20 bar as 32% and 35% respectively with CO selectivity 99.0 and 99.9% respectively indicating that the CO₂ conversion and CO selectivity of the Pt—ZnO—Al₂O₃ are much better than the ZnO—Al₂O₃ and Cu—ZnO—Al₂O₃ catalyst.

We claim:

1. A platinum impregnated zinc oxide-alumina (Pt/ZnO—Al₂O₃) catalyst comprising:
a zinc oxide-alumina (ZnO—Al₂O₃) support; and
a platinum (Pt) impregnated onto the ZnO—Al₂O₃ support,
wherein the platinum content is in the range of 0.6 to 1.2% w/w of the total weight of the catalyst.

2. The catalyst as claimed in claim 1, wherein the catalyst has pore volume in the range of 0.5 to 0.6 cm³/g, pore size in the range of 125 to 135 Å and surface are in the range of 110 to 120 m²/g.

3. A method of preparation of a platinum impregnated zinc oxide-alumina (Pt/ZnO—Al₂O₃) catalyst comprising:
a) mixing of a zinc metal salt and an aluminum metal salt in water to obtain a metal salt solution;
b) mixing of at least one base in water to obtain a base solution;
c) adding the metal salt solution of step a) in the base solution of step b) causes co-precipitation to obtain a precipitate;
d) processing the precipitate by washing followed by drying and calcination to obtain a zinc oxide-alumina (ZnO—Al₂O₃) support;
e) dispersing the ZnO—Al₂O₃ support in water with stirring to obtain a ZnO—Al₂O₃ support solution;
f) dissolving a platinum metal precursor in water to obtain a platinum metal precursor solution; and
g) mixing of ZnO—Al₂O₃ support solution of step e) with the platinum metal precursor solution to obtain a semi-solid solution followed by drying, calcination and reduced under condition to obtain a platinum impregnated zinc oxide-alumina (Pt/ZnO—Al₂O₃) catalyst.

4. The method as claimed in claim 3, wherein the zinc metal salt is selected from a group consisting of zinc nitrate hexahydrate, zinc chloride, zinc acetate, zinc chlorate and combination thereof.

5. The method as claimed in claim 3, wherein the aluminum metal salt is selected from a group consisting of aluminum nitrate nonahydrate, aluminum isopropoxide, aluminum chloride hexahydrate and combination thereof.

6. The method as claimed in claim 3, wherein the base is selected from a group consisting of sodium carbonate, sodium hydroxide, sodium acetate, sodium hypochlorite and combination thereof.

7. The method as claimed in claim 3, wherein the zinc metal salt and the aluminum metal salt are added in a mole ratio of 3:1.

8. The method as claimed in claim 3, wherein the precipitate in step c) has a age for 2 hrs at a temperature of 60° C. and having a pH in the range of 7 to 7.5.

9. The method as claimed in claim 3, wherein the precipitate in step d) is washed with warm water followed by drying at a temperature in the range of 100-120° C. for a period in the range of 8 to 12 hrs and calcined at a temperature in the range of 500-600° C. for a period in the range of 4 to 6 hrs with 1° C./min ramp rate.

10. The method as claimed in claim 3, wherein the platinum metal precursor is selected from a group consisting of tetra-amine platinum (II) nitrate, chloroplatinic acid hexahydrate and combination thereof and is added in an amount in the range of 0.6 to 1.2% w/w.

11. The method as claimed in claim 3, wherein the drying in step g) is carried out at a temperature in the range of 100-120° C. for a period in the range of 8 to 12 hrs and calcined at a temperature in the range of 300-500° C. for a period in the range of 3 to 5 hrs with 1° C./min ramp rate.

12. The method as claimed in claim 3, wherein the reduction in step g) is carried out by (i) in-situ reduction with sodium hydroborate and (ii) normal reduction using hydrogen and nitrogen with 50 ml/min and 950 ml/min respectively at 300° C. for 2 hrs or combination thereof.
